(19) United States
(12) Patent Application Publication
(10) Pub. No.: US 2022/0242001 A1
(43) Pub. Date: Aug. 4, 2022

(54) METHOD FOR REMOVING A CERAMIC COATING FROM A SUBSTRATE AND WATERJET MACHINE

(71) Applicant: Siemens Aktiengesellschaft, Munich (DE)

(72) Inventors: Jan Philipp Borrmann, Aachen (DE); Manuel Schüler, Aachen (DE); Kristian Arntz, Würselen (DE); Jens-Erich Döring, Dormagen (DE)

(73) Assignees: Siemens Aktiengesellschaft, Munich (DE); Fraunhofer Gesellschaft zur Förderung der angewandten Forschung e.V., München (DE)

(21) Appl. No.: 17/620,707

(22) PCT Filed: Mar. 25, 2020
(86) PCT No.: PCT/EP2020/058337

§ 371 Date: Dec. 19, 2021

(30) Foreign Application Priority Data
Jun. 28, 2019 (EP) 19183182.5

(51) Int. Cl. B26F 3/00; B08B 3/02

(52) U.S. Cl. CPC B26F 3/004; B08B 3/024

(57) ABSTRACT

A method and a waterjet machine for removing or stripping a ceramic coating from a substrate, especially from a metallic coating onto the substrate, using a pure waterjet without any additions. The method includes providing a water source and a nozzle for ejecting a jet of pure water onto the surface of a coated substrate; providing a substrate coated at least with a ceramic coating; positioning the nozzle and the substrate to one other such that a machining angle can be determined between the waterjet and the surface of the coated substrate at the location of impingement of the water jet onto the local coating surface; ejecting a pure waterjet by the nozzle impinging the ceramic coating for removing essentially or completely the ceramic coating from the substrate or from the metallic coating.

### CROSS REFERENCE TO RELATED APPLICATIONS

This application is the US National Stage of International Application No. PCT/EP2020/058337 filed 25 Mar. 2020, and claims the benefit thereof. The International Application claims the benefit of European Application No. EP19183182 filed 28 Jun. 2019. All of the applications are incorporated by reference herein in their entirety.

### FIELD OF INVENTION

The present invention relates to a method for removing a ceramic coating from a substrate. Moreover, the present invention relates to a waterjet machine for performing such method.

### BACKGROUND OF INVENTION

Gas turbine blades are high-performance parts which have to resist chemical, mechanical and thermal stresses resulting from gas turbine operation. In order to withstand these collective stresses turbine blades are made of high-performance materials, typically nickel-based superalloys. The most common way of manufacturing turbine blades is done by investment casting. For additional thermal protection different active and passive cooling systems are used. Apart from a complex cooling airflow a bilayer coating system is applied on all hot gas components. A typical system structure consists of a metallic bond coat and a ceramic thermal barrier coating (TBC). The chemical composition of a bond coat is McrAlY; the TBC is commonly made of yttria-stabilized zirconia (YSZ). Both coatings are applied by thermal spraying.

Due to wear and degradation of turbine blades during operation, a periodic maintenance and repair process is needed. A central process is the removal of the bilayer coating system, which consists of many process steps. The removal of TBC is typically done by a manual grid blasting process. Afterwards the cooling channels inside the blade are filled with wax in order to protect the base material against the acids used during the bond coat removing procedure. The bond coat is removed by several chemical stripping processes by means of acid baths. In case of partial incomplete stripping, the coating residues are removed by manual grid blasting. The final process step is burning off the wax. A selective removal of TBC without damaging the bond coat is not feasible with these common processes but would be very beneficial for new alternative overhaul processes of turbine blades.

### SUMMARY OF INVENTION

Starting from this prior art it is an object of the present invention to provide an alternative method for removing a ceramic coating from a substrate.

In order to solve this object the present invention provides a method for removing (stripping) a ceramic coating from a substrate, especially from a metallic coating onto the substrate, such a metallic bond coat, using a waterjet without any additions, i.e. a pure waterjet, comprising the steps of: providing a water source for supplying pure water to nozzle, the water source is able to supply water with a supply pressure in the range between 600 bar and 1500 bar; providing a nozzle for ejecting a jet of pure water onto the surface of a coated substrate, the nozzle is connected to the water source; providing a substrate coated at least with a ceramic coating; positioning the nozzle and the substrate to one other such that a machining angle can be determined between the waterjet and the surface of the coated substrate at the location of impingement of the water jet onto the local coating surface, wherein the machining angle is in the range between 30° and 70°, especially is 40°±5°; ejecting a pure waterjet by the nozzle impinging the ceramic coating for removing essentially or completely the ceramic coating from the substrate or from the metallic coating and moving relatively the location of the waterjet impingement and the substrate with a velocity (feed rate) between 1500 mm/min and 2500 mm/min, especially of 2000 mm/min.

Applicants have found out that a pure waterjet machining process shows high potential for the application of selective and partial TBC stripping. Choosing a machining angle in the range between 30° and 70°, especially is 40°±5°, provides very satisfying results. A feed rate spectrum between 1500 mm/min and 2500 mm/min, especially a feed rate of 2000 mm/min, showed the highest possible feed rate without significant feet rate drops in turning points of feed rate direction based on the dynamics of the waterjet machine. Using much lower feed rates would result in a decreasing economic efficiency.

According to an aspect of the present invention the nozzle has a water orifice with a diameter, the diameter is in the range between 0.2 mm and 0.5 mm.

Advantageously, the water orifice has a diameter of 0.35 mm.

According to an aspect of the present invention a focusing tube is provided, wherein the focusing tube is arranged downstream the water orifice, and wherein the focusing tube has a bore with a diameter in the range between 2 mm and 4 mm, especially a diameter of 3 mm.

Advantageously, the waterjet meanders over the surface of the coating creating a continuous line of multiple sections by the itinerary of the waterjet, wherein at least two sections are straight and being substantially parallel to one another with a hatch distance between said parallel sections, wherein the hatch distance is the range between 0.5 mm and 1.5 mm. Studies showed best results with this hatch distance. Higher hatch distances would result in linear residues of TBC. Smaller hatch distances would lead to a decreasing economic efficiency.

According to an aspect of the present invention a bond coat, especially made from MCrAlY, is located between the ceramic coating and the substrate, the bond coat at least substantially being not removed from the waterjet.

Advantageously, the pure water is deionized water or tab water, substantially without any abrasive parts.

Moreover, the present invention provides a waterjet machine for performing the method according to the present invention.

### BRIEF DESCRIPTION OF THE DRAWINGS

Further features and advantages of the present invention will become apparent by means of the following description of an embodiment of the present invention with reference to the accompanying drawing. In the drawing

FIG. 1 is a schematically perspective view of a gas turbine blade;

FIG. 2 is a schematic sectional view of a blade section of the gas turbine blade;

FIG. 3 is a schematic view of a waterjet machine;

FIG. 4 is a schematically perspective view of a gas turbine blade corresponding to FIG. 1 showing the tool path design;

FIG. 5 is an enlarged view of section V in FIG. 4;

FIG. 6 is a schematic view of the tool path and

FIG. 7 is a schematic sectional view of a blade section of the gas turbine blade corresponding to FIG. 4, wherein the thermal barrier coating is partly removed.

### DETAILED DESCRIPTION OF INVENTION

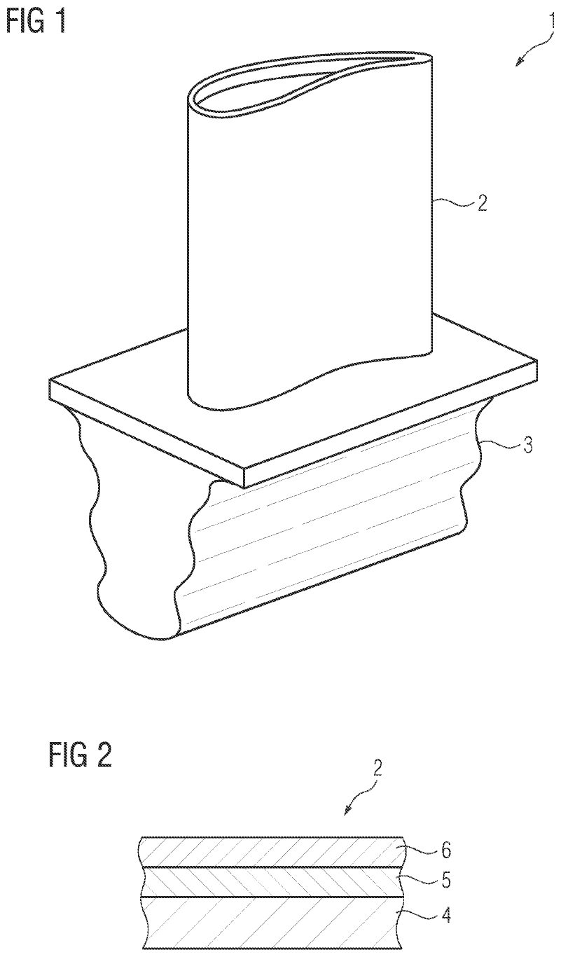

FIG. 1 shows a gas turbine blade 1 having a blade section 2 and a root section 3. The blade section 2 is a layered structure comprising a substrate 4, a metallic bond coat 5 and a ceramic thermal barrier coating 6 (TBC) as schematically shown in FIG. 2. The chemical composition of the bond coat 5 is McrAlY. The thermal barrier coating 6 is commonly made of yttria-stabilized zirconia (YSZ). Both coatings 5 and 6 are applied by thermal spraying.

The following describes the investigation of a pure waterjet application according to the present invention for selective stripping of the thermal barrier coating 6. This process should be economically usable by industry for partial and extensive removing of TBC 6 on gas turbine blades 1. For an adequate automation of this process a CAx toolchain is needed. The bond coat 5 must not be damaged, influenced or contaminated by this waterjet process. The development can be subdivided in the following chapters: 1) Development of CAx toolchain in Siemens NX, 2) Preliminary studies for process parametrization on flat test samples (variation of water pressure, feed rate, hatch distance), 3) Transfer to freeform surfaces, like turbine blades (investigation of influence of machining angle), 4) Evaluation of different machining strategies, 5) Metallographie analyses of machined surfaces.

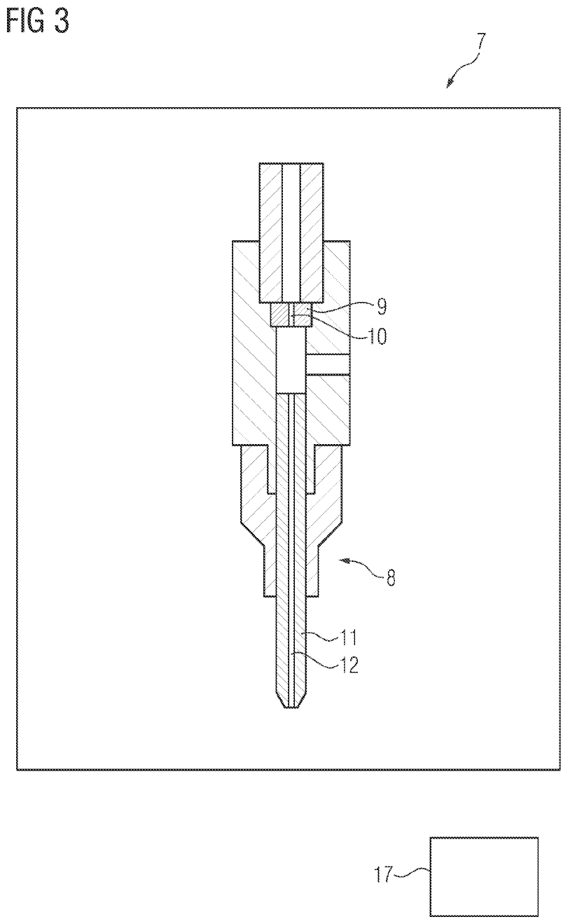

The practical investigations were carried out on a 5-axis waterjet machine by H.G. Ridder Automatisierungs GmbH Type HWE-P2030 indicated by box 7 in FIG. 3, wherein the waterjet machine 7 is connected to a water source 17 for supplying pure water to nozzle, the water source 17 is able to supply water with a supply pressure in the range between 600 bar and 1500 bar. In addition to the standard XYZ-axes in gantry machine design there is a swivel (B) and rotating (C) axis implemented in the machining head 8. This allows a flexible waterjet machining of complex freeform surfaces. For the machining head 8 itself a standard abrasive waterjet head 8 also by H.G. Ridder was used. The machining head 8 comprises a nozzle 9 with water orifice 10 having a diameter of 0.3 mm and a focusing tube 11 with a bore 12 having a diameter of 1.0 mm. Preliminary studies showed best results for removing the brittle thermal barrier coating 6 with this approach by utilization of droplet erosion in comparison to a pure waterjet machining head.

For analysing the waterjet machined surfaces two methods were applied. Firstly, a visual analysis by microscopy of metallographically prepared cross-sections was done. Secondly the individual surface texture was measured and compared using an optical 3D surface measurement system by Alicona Type InfiniteFocus.

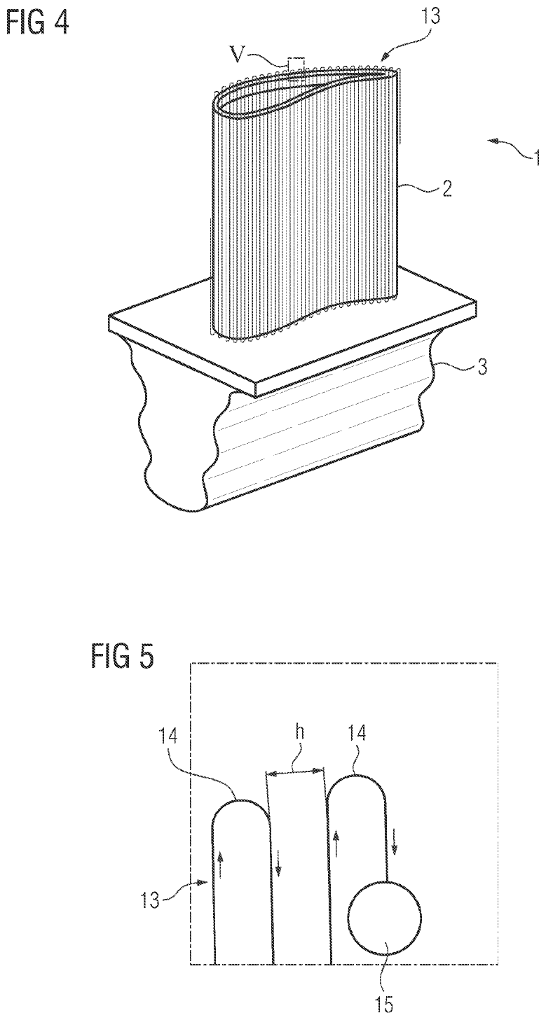

The basis of the development of CAx toolchain in Siemens NX is a CAD model of the to be machined workpiece, in this case the gas turbine blade 1. As a preparation for the meander-formed tool path design an additional construction plane is needed. This enables the flexible creation of a plane tool path 13. Most important characteristics of this tool path 13, like hatch distance h and turning points 14, can be designed on an automated way. The final step is the projection of this tool path 13 to the free-form surface. This was done by an arc length projection method to ensure that the designed tool path geometry is not warped. A schematic drawing of this CAD approach is shown in FIGS. 4, 5 and 6.

Currently there is no CAM function for waterjet machining processes available in commonly used CAD-CAM software, like Siemens NX. Therefore, the function of a milling operation was used. The tool setting was a ball cutter with a diameter of 1 mm, as this tool emulates the used waterjet tool best. Especially the angle between the tool and the to be machined surface can be adjusted in this step. This criterion is very significant for the waterjet process itself. To get a first impression of the machining process a path simulation of the tool movement is possible. Simulation of waterjet process itself is currently not possible. Therefore, a completely new designed CAM-module for waterjet machining would be necessary.

The transfer of the designed tool path to the waterjet machine 7 was done by a customized postprocessor. This postprocessor was designed within the Postbuilder function in Siemens NX, The final issued G-code was directly transferred to the Sinumerik 840D sl control of the waterjet machine 7. This CAx toolchain enables a flexible toolpath generation.

For a parametrization of the pure waterjet stripping process the first trials were conducted on flat plates coated with a bond coat 5 and a thermal barrier coating 6. The tool path was meander-formed as shown in FIGS. 4 to 6 with a hatch distance h of 0.5 mm. Preliminary studies showed best results with this hatch distance h. Higher hatch distances h resulted in linear residues of the thermal barrier coating 6; smaller hatch distances h would lead to a decreasing economic efficiency. The investigated influencing parameters were the pressure and feed rate. The target was to remove the thermal barrier coating 6 completely without damaging the metallic bond coat 5.

In order to gain a cost effective process, a strategy of processing more surface area within the same time was tested. Therefore, an experimental setup to increase the effective waterjet diameter was implemented. It consists of a nozzle 9 having a water orifice 10 with a diameter of 0.35 mm in combination with a customized tool head 8 using a focusing tube 11 having a bore 12 with a diameter of 3.0 mm.

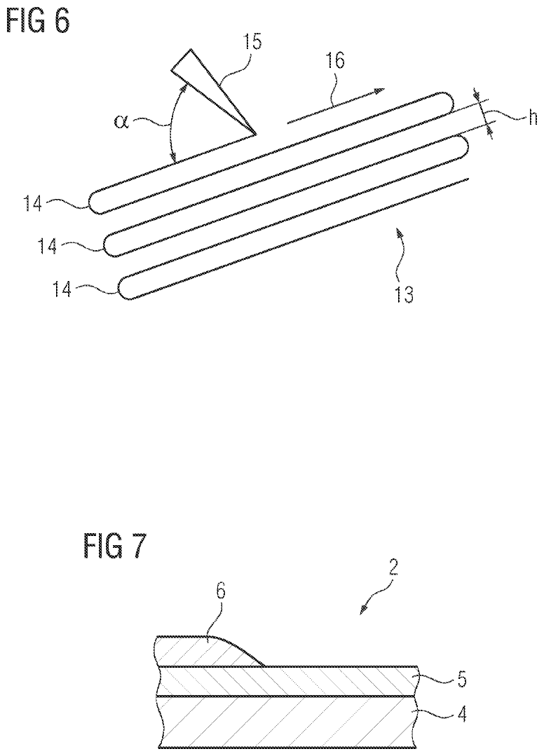

The last step is the transfer of the developed process to complex free-form surfaces like gas turbine blades 1. Therefore, the influence of the machining angle α between the waterjet 15 and the surface of the coated substrate 4 at the location of impingement of the water jet 15 onto the local coating surface (see FIG. 6) has to be investigated.

The parametrization studies showed significant influence of pressure and feed rate on the removed thermal barrier coating 6. The range for variating the feed rate, which is indicated by arrow 16 in FIG. 6, was between 1500 and 2500 mm/min. This feed rate spectrum showed the highest possible feed rate without significant feed rate drops in turning points of feed direction based on the dynamics of the waterjet machine. Using much lower feed rates would result in a decreasing economic efficiency. The investigated range for pressure was between 600 and 1500 bar. An exemplary picture of the results of parametrization studies is showed in FIG. 6.

The best results in terms of a selective removal of the thermal barrier coating 6 without residues were achieved with a combination of a pressure of 1000 bar and a feed rate of 2000 mm/min. This was proven by a visual analysis of the metallographically prepared cross-section. Neither residues of the thermal barrier coating 6 nor a damaging of the metallic bond coat 5 was visible. Even the roughness of the bond coat 5 was not changed in the waterjet stripped areas 13.

The next step was the economically optimization by increasing the effective waterjet diameter while using a customized machining head 8. As the factor between the diameter of bore 12 of focusing tube 11 and tool path hatch distance h should stay the same, the hatch distance h was adjusted to 1.5 mm. Parametrization of pressure and feed rate could be arranged in the same range. As a result, the surface area machined in the same time with this modification could be three times higher, benchmarked to the initially machining head setup and the waterjet process is up scalable. The achieved stripping rate is around 3000 mm²/min.

For an off-line analysis of the stripped surface the texture was measured by an optical 3D surface measuring system. The focus was on the root mean square height S_{q}, as this characteristic value describes the stochastically distributed surface best. The originally plasma sprayed surface texture of the bond coat 5 was compared to the structure of the bond coat 5 after the stripping of the thermal barrier coating 6. Comparison of root mean square height Sq shows nearly the same value. The highest difference comparing both Sq values was less than 5%. Summarized there was no influence of waterjet stripping process on the surface of bond coat 5 determined.

As preparation for extensive TBC stripping of a gas turbine blade 1 the influence of machining angle α was investigated. This was done by stripping a turbine blade section close to the leading edge with a high curvature. The machining head 8 was fixed rectangular to work piece and travelled, in single lines over the curved area.

Up to a machining angle α of 40° deviated from a perpendicular waterjet on the work piece the thermal barrier coating 6 is completely removed. A machining angle α between 40° and 70° leads to a partial removing of the thermal barrier coating 6. Using machining angles α higher than 70° the waterjet has nearly no influence on the thermal barrier coating 6. Based on these results the customized postprocessor was optimized, so that a machining angle α±40° deviated from a rectangular angle between waterjet and work piece is tolerable.

The final step of this investigation was the transfer of the developed process to a gas turbine blade 1. The target was to remove the thermal barrier coating 6 extensively on the airfoil profile. Therefore, two machining strategies regarding the tool path were developed with the CAx toolchain. The first strategy was to use a horizontal orientated meander-formed tool path in relation to the blade tip. Testing this method extensive feed rate drops in the areas with a high surface curvature were investigated, based on the limited dynamic of the swivel axis. This resulted in a partly damaged bond coat 5. The reason is the higher energy input per unit length (“intensity”) of the waterjet in these areas. This problem was fixed by using a vertical orientated tool path, as this method showed significant less areas with high surface curvature. The movement of the swivel axis was positioned outside the blade above the blade tip.

The thermal barrier coating 6 was extensively completely removed on the airfoil by the waterjet. FIG. 7 shows the transfer between a machined area and an unmachined area. Exemplary analyses of the surface texture showed no influence of waterjet stripping process on the surface of the bond coat 5.

In summary the development of a pure waterjet controlled depth machining process for stripping a ceramic thermal barrier coating 6 on gas turbine blades 1 was explained. The developed CAx toolchain enabled a flexible option for tool path planning. The parametrization and economically optimization of the waterjet process itself led to extensively or locally restricted removal of the thermal barrier coating 6 without influencing the metallic bond coat 5. Removing the thermal barrier coating 6 on a complete turbine blade airfoil showed enormous potential for an innovative non-conventional overhaul process.

Although the present invention has been illustrated and described in greater detail with reference to the exemplary embodiment, the invention is not limited to the examples disclosed and further variations can be inferred by a person skilled in the art, without departing from the scope of protection of the invention.

1. A method for removing or stripping a ceramic coating from a substrate or from a metallic coating on the substrate, using a waterjet without any additions, comprising:
providing a water source for supplying pure water to a nozzle, the water source adapted to supply water with a supply pressure in the range between 600 bar and 1500 bar,
providing the nozzle for ejecting a jet of pure water onto the surface of a coated substrate, the nozzle is connected to the water source,
providing a substrate coated at least with a ceramic coating,
positioning the nozzle and the substrate to one other such that a machining angle can be determined between the waterjet and the surface of the coated substrate at the location of impingement of the water jet onto the local coating surface,
wherein the machining angle is in the range between 30° and 70°,
ejecting a pure waterjet by the nozzle impinging the ceramic coating for removing essentially or completely the ceramic coating from the substrate or from the metallic coating on the substrate, and
moving relatively the location of the waterjet impingement and the substrate with a velocity or feed rate between 1500 mm/min and 2500 mm/min.

2. The method according to claim 1,
wherein the nozzle has a water orifice with a diameter, the diameter is in the range between 0.2 mm and 0.5 mm.

3. The method according to claim 2,
wherein the water orifice has a diameter of 0.35 mm.

4. The method according to claim 2,
wherein a focusing tube is provided, wherein the focusing tube is arranged downstream the water orifice, and wherein the focusing tube has a bore with a diameter in the range between 2 mm and 4 mm.

5. The method according to claim 1,
wherein the waterjet meanders over surface of the ceramic coating creating a continuous line of multiple sections by the itinerary of the waterjet, wherein at least two sections are straight and being substantially parallel to one another with a hatch distance between said parallel sections, wherein the hatch distance is the range between 0.5 mm and 1.5 mm.

6. The method according to claim 1,
wherein a bond coat is located between the ceramic coating and the substrate, the bond coat at least substantially being not removed by the waterjet.

7. The method according to claim 1,
wherein the pure water is deionized water or tab water, substantially without any abrasive parts.

8. A waterjet machine adapted for performing the method according to claim 1.

9. The method according to claim 1,
wherein the machining angle is 40°±5°.

10. The method according to claim 1,
wherein the velocity or feed rate is 2000 mm/min.

11. The method according to claim 4,
wherein the focusing tube has a bore with a diameter of 3 mm.

12. The method according to claim 6,
wherein the bond coat is made from MCrAlY.
